(19) United States
(12) Patent Application Publication
(10) Pub. No.: US 2025/0323288 A1
(43) Pub. Date: Oct. 16, 2025

(54) METAL-OXYGEN BATTERY AND METHOD OF USE THEREOF

(71) Applicant: Form Energy, Inc., Somerville, MA (US)

(72) Inventors: Joseph S. Manser, Reading, MA (US); Christopher Thomas Reynolds, Arlington, MA (US); Liang Su, Medfield, MA (US); Nicholas Perkins, Emeryville, CA (US)

(21) Appl. No.: 19/175,169

(22) Filed: Apr. 10, 2025

Related U.S. Application Data
(60) Provisional application No. 63/632,429, filed on Apr. 10, 2024.

(51) Int. Cl. H01M 8/04089; H01M 8/0438; H01M 8/04537; H01M 8/04746; H01M 8/18; H01M 10/48; H01M 12/08

(52) U.S. Cl. CPC H01M 8/04089; H01M 8/04395; H01M 8/04604; H01M 8/04753; H01M 8/186; H01M 10/48; H01M 12/08

(57) ABSTRACT

A metal-oxygen battery system, including: an electrochemical cell including a positive electrode, a negative electrode, and an electrolyte between the positive electrode and the negative electrode; and an energy storage reactor in fluid communication with the negative electrode; a gas store in fluid communication with the positive electrode, the gas store configured to store oxygen; and a fuel gauge configured to determine a state of charge, wherein the gas store and the positive electrode form a closed system.

### CROSS REFERENCE TO RELATED APPLICATION

This application claims priority to and the benefit of U.S. Provisional Patent Application No. 63/632,429, filed Apr. 10, 2024, in the United States Patent and Trademark Office, the content of which in its entirety is hereby incorporated by reference.

### BACKGROUND

This disclosure relates to a metal-oxygen battery, a method of use thereof, and methods of manufacturing the metal-oxygen battery.

### SUMMARY

Provided is a metal-oxygen battery system, comprising: an electrochemical cell including a positive electrode, a negative electrode, and an electrolyte between the positive electrode and the negative electrode; and an energy storage reactor in fluid communication with the negative electrode; a gas store in fluid communication with the positive electrode, the gas store configured to store oxygen; and a fuel gauge configured to determine a state of charge, wherein the gas store and the positive electrode form a closed system.

Also disclosed is a battery fuel gauge configured to determine a state of charge of an metal-oxygen battery, wherein the battery fuel gauge comprises a processor configured to receive information relating to a position of a barrier of a gas store and to determine the state of charge based on the position of the barrier; wherein the metal-oxygen battery comprises: an electrochemical cell including a positive electrode, a negative electrode, and an electrolyte between the positive electrode and the negative electrode; an energy storage reactor in fluid communication with the negative electrode; and the gas store in fluid communication with the positive electrode, the gas store configured to store oxygen, wherein the gas store comprises the barrier, wherein the gas store and the positive electrode of the electrochemical cell form a closed system, or a system with a constant volume.

Also disclosed is a method of operating a metal-oxygen battery system, the method including: providing a metal-oxygen battery system; supplying electricity and water to the electrochemical cell to charge the battery system, wherein metal oxide and hydrogen are converted in the energy storage reactor to the metal and water, water is converted to hydrogen and oxygen by the electrochemical cell, the hydrogen produced by the electrochemical reactor is transferred to the energy storage unit, and the oxygen produced by the electrochemical reactor is stored in the gas store; and discharging the metal-oxygen battery system to covert hydrogen and oxygen to water and produce electricity, wherein the metal and water are converted in the energy storage reactor to metal oxide and hydrogen, hydrogen and oxygen are converted to water by the electrochemical cell, the water produced by the electrochemical reactor is transferred to the energy storage reactor, and the oxygen is provided by the gas store.

Also disclosed is a method of operating a metal-oxygen battery system, the method including: providing a metal-oxygen battery system; supplying electricity and carbon dioxide to the electrochemical cell to charge the battery system, wherein metal oxide and carbon monoxide are converted in the energy storage reactor to metal and carbon dioxide, carbon dioxide is converted to carbon monoxide and oxygen by the electrochemical cell, the carbon monoxide produced by the electrochemical reactor is transferred to the energy storage unit, and the oxygen produced by the electrochemical reactor is stored in the gas store; and discharging the metal-oxygen battery system to covert carbon monoxide and oxygen to carbon dioxide and produce electricity, wherein metal and carbon dioxide are converted in the energy storage reactor to metal oxide and carbon monoxide, carbon monoxide and oxygen are converted to carbon dioxide by the electrochemical cell, the carbon dioxide produced by the electrochemical reactor is transferred to the energy storage reactor, and the oxygen is provided by the gas store.

The above and other aspects and features are described and exemplified by the following figures and detailed description.

### BRIEF DESCRIPTION OF THE DRAWINGS

The following figures are exemplary embodiments wherein the like elements are numbered alike.

FIG. 1 is a schematic diagram of an embodiment of a metal-oxygen battery system employing passive flow in a charged state;

FIG. 2 is a schematic diagram of an embodiment of a metal-oxygen battery system employing passive flow in a discharged state;

FIG. 3 is a schematic diagram of an embodiment of a metal-oxygen battery system employing passive flow in a charged state;

FIG. 4 is a schematic diagram of an embodiment of a metal-oxygen battery system employing passive flow in a discharged state;

FIG. 5 is a schematic diagram of an embodiment of a metal-oxygen battery system employing active flow.

### DETAILED DESCRIPTION

Metal-oxygen battery systems include an electrochemical cell that converts H₂O to H₂ and O₂ on charge, or H₂ and O₂ to H₂O on discharge, and an energy storage reactor that either converts FeO and H₂ to Fe(s) and H₂O on charge, or provides FeO and H₂ from Fe and H₂O on discharge.

Alternatively, the electrochemical cell can convert CO₂ to CO and O₂ on charge, or CO and O₂ to CO₂ on discharge, and an energy storage reactor that either converts FeO and CO to Fe(s) and CO₂ on charge, or provides FeO and CO from Fe and CO₂ on discharge.

Both the H₂O and the CO₂ systems have the same net reaction, which proceeds to the right on charge and to the left on discharge, as provided in Reaction 1.

FeO↔Fe+½O₂ (1)

Due to their attractive materials cost, iron-oxygen battery systems are desirable for stationary storage applications.

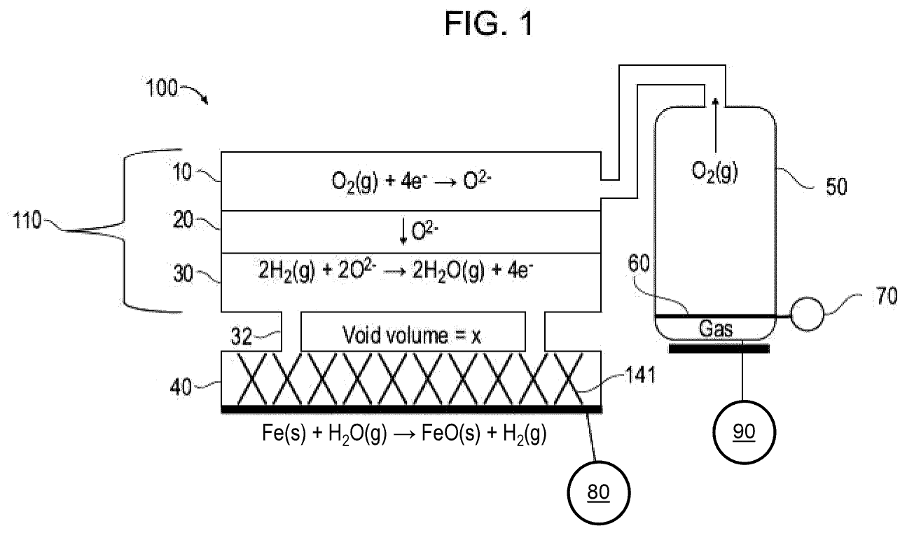

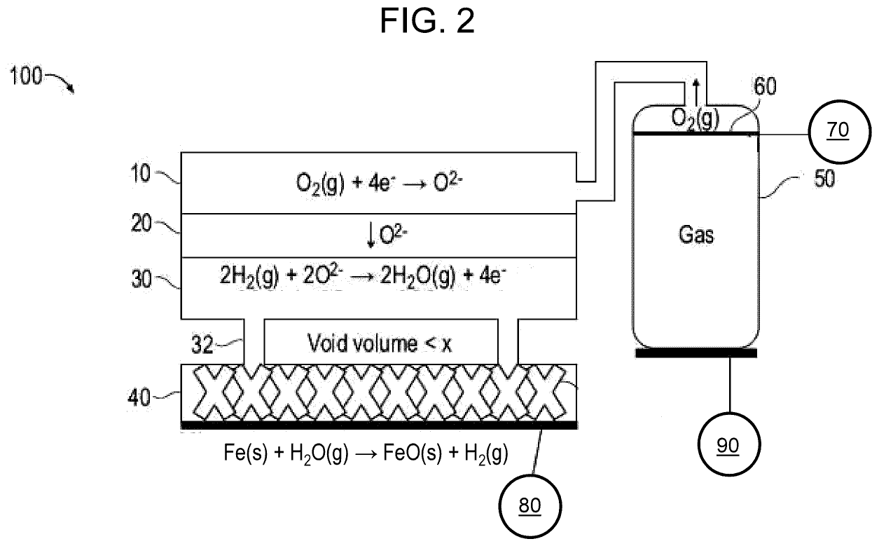

FIGS. 1 and 2 provide an illustration of the charging process for a passive flow H₂/H₂O-type metal-oxygen battery system that includes an electrochemical cell and an energy storage reactor. During charge, the metal oxide is reduced to form the metal and water, driven by water electrolysis in the electrochemical cell which provides hydrogen and oxygen. The reverse occurs on discharge, the metal is oxidized to form metal oxide and hydrogen, and the hydrogen is combined with oxygen in the electrochemical cell to generate electricity. The metal may be iron, tin, tungsten, cobalt, zinc, molybdenum, cadmium, copper, lead, or a combination thereof, preferably iron. FIG. 1 provides an illustration of an H₂/H₂O-type iron-oxygen battery system at nearly 100% state of charge and FIG. 2 provides an illustration of an H₂/H₂O-type iron-oxygen battery system at nearly 0% state of charge.

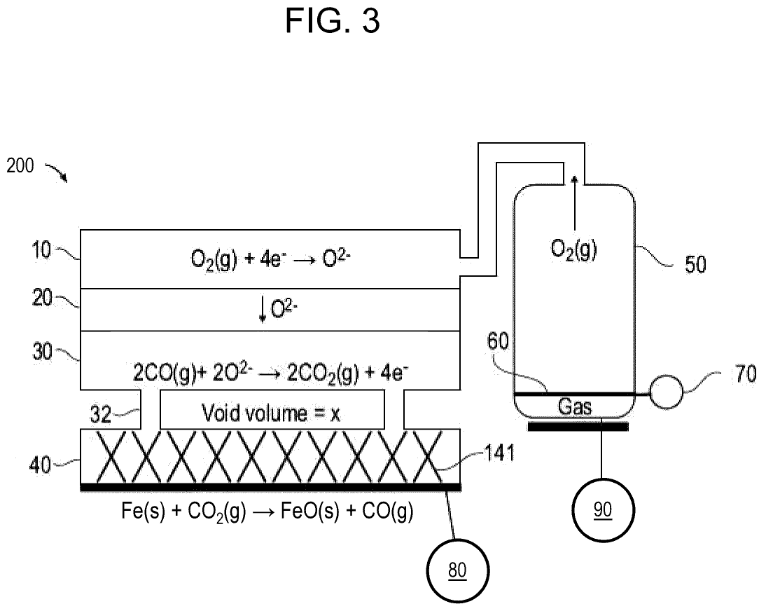

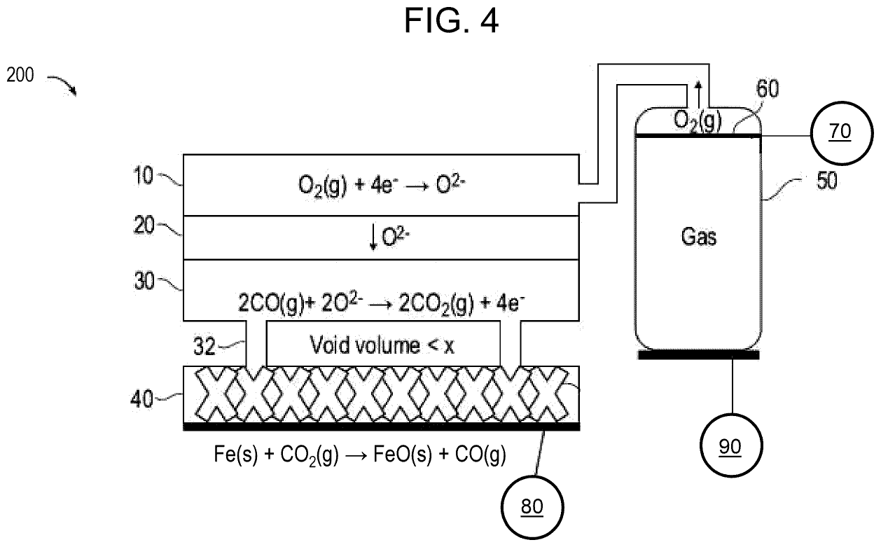

Alternatively, as shown in FIGS. 3 and 4, on charge, iron oxide is reduced using CO to form iron metal and CO₂, driven by electrolysis of CO₂ in the electrochemical cell, which provides CO and oxygen. The reverse occurs on discharge, iron is oxidized to form iron oxide and CO, and the CO is combined with oxygen in the electrochemical cell to form CO₂ and generate electricity. FIG. 3 provides an illustration of a passive flow CO/CO₂-type iron-oxygen battery system at nearly 100% state of charge and FIG. 4 provides an illustration of a CO/CO₂-type metal-oxygen battery system at nearly 0% state of charge.

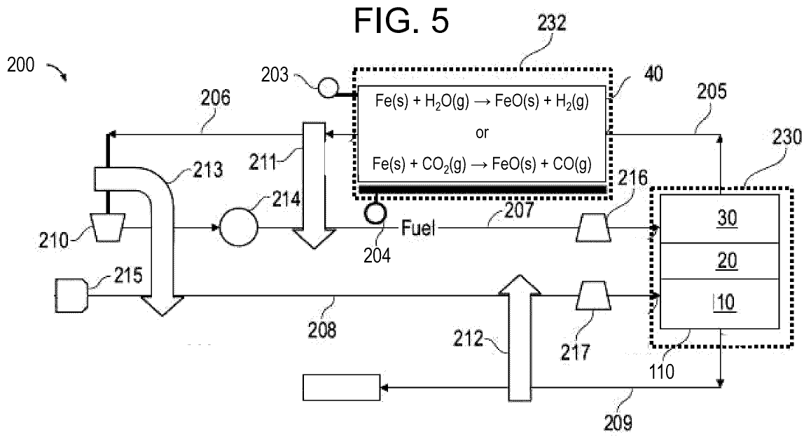

FIG. 5 illustrates an active flow system for an H₂/H₂O-type or a CO/CO₂-type metal-oxygen battery system.

There remains a need for such systems having a state of charge or fuel gauge feature.

An aspect provides an metal-oxygen battery system 100, comprising: an electrochemical cell 110 comprising a positive electrode 10, a negative electrode 30, and an electrolyte 20 between the positive electrode and the negative electrode; and an energy storage reactor 40 in fluid communication with the negative electrode; a gas store 50 in fluid communication with the positive electrode, the gas store configured to store oxygen, wherein the gas store comprises a barrier 60; and a fuel gauge 70 configured to determine a state of charge based on a position of the barrier, wherein the gas store and the positive electrode form a closed system, or a system with a constant volume. The system 100 can further comprise a fuel gauge 80 to determine a state of charge based on a mass or a volume of an energy storage material within the energy storage reactor 40 or a fuel gauge 90 to determine a state of charge based on a pressure or a mass of gas within the gas store 50.

For an active flow metal-oxygen battery system 200, the electrochemical reactants of fuel and gas can be actively conveyed by a fuel blower 214 and a gas blower 215 to the electrochemical cell 110. The fuel blower 214 and the gas blower 215 consume power to convey the electrochemical reactants. Heaters 216 and 217 can be used to heat the fuel and gas, respectively. The electrochemical cell 110 can be in fluid communication with the stream through conduit 205 with the energy storage reactor 40. The energy storage reactor can include a fuel gauge 203 for sensing pressure drop through the condensed phase energy storage material, a fuel gauge 204 for sensing mass or volume of the condensed phase energy storage material, or a combination thereof. Heat exchangers 211, 212, and 213 can serve to increase system efficiency by facilitating the heat exchange of the electrochemical reactants and products. The electrochemical reactants and products can be transported throughout the system via conduits 205, 206, 207, 208, and 209. The electrochemical cell 110 and the energy storage reactor 40 may be disposed in thermal chambers 230 and 232, respectively. In an aspect, at least one of the energy storage reactor 40 and the electrochemical cell 110 may be disposed in a thermal chamber. The electrochemical cell 110 and the energy storage reactor 40 may be disposed in a thermal chamber together or separately as shown in FIG. 5.

The positive electrode 10 may be any suitable oxygen electrode. Exemplary positive electrode materials include lanthanum strontium cobalt ferrite (LSCF), strontium-doped lanthanum manganate, strontium oxide and bismuth oxide doped with lanthanum manganate, lanthanum strontium cobaltite (LSC), barium strontium iron cobaltite (BSCF), strontium doped hafnium oxide, europium cobaltite (SSC), or the like, or a combination thereof. In some embodiments, the positive electrode may include lanthanum strontium cobalt ferrite (LSCF). In other embodiments, the positive electrode may include Bi₂O₃-MO (wherein Mis one or more of Ca, Sr, Ba, or Cu), Bi₂O₃-MO₂ (wherein M is one or more of Ti, Zr, or Te), Bi₂O₃-MO₃ (wherein M is one or more of W or Mo), Bi₂O₃-M₂O₅ (wherein M is one or more of V, Nb, or Ta), Bi₂O₃-M₂O₃ (wherein M is one or more of La, Sm, Y, Gd, or Er), nickel, a lithiated nickel oxide, or a combination thereof. The negative electrode 30 may be any suitable anode material. The negative electrode 104 may include an electron-conducting material and ceria doped with one or more rare earth elements such as Gd, Sm, Pr, La, Y, or Yb, and/or one or more other elements such as Mn or Fe. The electron-conducting material may include ceramic oxides such as Sr-doped lanthanum chromite, Nb-, La-, or Y-doped strontium titanate, strontium iron molybdate, or the like, or a combination thereof, and/or metals such as copper, silver, or the like, or a combination thereof. Exemplary negative electrode materials includes nickel oxide (NiO), cerium oxide (CeO₂), copper oxide (CuO), strontium titanate (SrTiO₃), yttrium oxide doped strontium titanate (YST), thorium oxide doped strontium titanate (SST), or the like, or a combination thereof. Other exemplary negative electrode materials may include ceramic oxides such as lanthanum strontium chromite, strontium iron molybdate, copper, silver, or the like, or a combination thereof. The electrolyte may comprise any suitable electrode, and may comprise a solid oxide electrolyte, a molten carbonate electrolyte, or a combination thereof. Use of a solid electrolyte is mentioned. Representative electrolytes include a sulfide solid electrolyte. Examples of the sulfide solid electrolyte may include at least one of Li₂S-P₂S₅, Li₂S-P₂S₅-LiX (where X is a halogen element), Li₂S-P₂S₅-Li₂O, Li₂S-P₂S₅-Li₂O-LiI, Li₂S-SiS₂, Li₂S-SiS₂-LiI, Li₂S-SiS₂-LiBr, Li₂S-SiS₂-LiCl, Li₂S-SiS₂-B₂S₃-LiI, Li₂S-SiS₂-P₂S₅-LiI, Li₂S-B₂S₃, Li₂S-P₂S₅-ZmSn (where m and n each are a positive number, Z represents any of Ge, Zn, and Ga), Li₂S-GeS₂, Li₂S-SiS₂-Li₃PO₄, Li₂S-SiS₂-LiₚMO_{q} (where p and q each are a positive number, M represents at least one of P, Si, Ge, B, Al, Ga, or In), Li₇₋ₓPS₆₋ₓClₓ (where 0≤x≤2), Li₇₋ₓPS₆₋ₓBrₓ (where 0≤x≤2), or Li₇₋ₓPS₆₋ₓIₓ (where 0≤x≤2). The sulfide solid electrolyte may be prepared by melting and quenching starting materials (e.g., Li₂S or P₂S₅), or mechanical milling the starting materials. The sulfide solid electrolyte may be amorphous or crystalline and may be a mixed form thereof. The electrolyte may comprise an oxide such as Li_{1+x+y}AlₓTi₂₋ₓSi_{y}P_{3-y}O₁₂ (where 0<x<2 and 0≤y<3), BaTiO₃, Pb(ZrₐTi₁₋ₐ)O₃ (PZT) (where 0≤a≤1), Pb₁₋ₓLaₓZr_{1-y} Ti_{y}O₃ (PLZT) (where 0≤x<1 and 0≤y<1), Pb(Mg_{1/3}Nb_{2/3})O₃-PbTiO₃ (PMN-PT), HfO₂, SrTiO₃, SnO₂, CeO₂, Na₂O, MgO, NiO, CaO, BaO, ZnO, ZrO₂, Y₂O₃, Al₂O₃, TiO₂, SiO₂, Li₃PO₄, LiₓTi_{y}(PO₄)₃ (where 0<x<2 and 0<y<3), LiₓAl_{y}Ti_{z}(PO₄)₃ (where 0<x<2, 0<y<1, and 0<z<3), Li_{1+x+y}(AlₐGa₁₋ₐ)ₓ(Ti_{b}Ge_{1-b})₂₋ₓSi_{y}P_{3-y}O₁₂ (where 0≤x≤1, 0≤y≤1, 0≤a≤1, and 0≤b≤1), LiₓLa_{y}TiO₃ (where 0<x<2 and 0<y<3), Li₂O, LiOH, Li₂CO₃, LiAlO₂, Li₂O-Al₂O₃-SiO₂—P₂O₅—TiO₂-GeO₂, or Li₃₊ₓLa₃M₂O₁₂ (where Mis Te, Nb, or Zr, and 0≤x≤10).

The energy storage reactor is configured to convert metal to metal oxide and hydrogen in a discharge mode; and configured to convert metal oxide to metal and water in a charge mode. Alternatively, the energy storage reactor is configured to convert metal to metal oxide and carbon monoxide in a discharge mode; and figured to convert metal oxide to metal and carbon dioxide in a charge mode. In an aspect, the energy storage reactor may comprise a catalyst for metal oxidation and reduction. The catalyst may be contained within a compartment of the negative electrode, and be in fluid communication with the negative electrode through an interconnect 32. Alternatively, the catalyst may be separate from the negative electrode and in the energy storage reactor and fluid communication with the negative electrode through the interconnect.

The energy storage reactor may be disposed within a compartment of the negative electrode of the electrochemical cell, in a separate compartment from the electrochemical cell, or in an interconnect. The interconnect may include connections to a plurality of electrochemical cells

In operation, the metal-oxygen battery system is configured to generate an automatic gas flow between the positive electrode and the gas store. As shown in FIG. 1, on discharge O₂ gas is transferred from the gas store and consumed in electrochemical cell, and the reverse on charge, thus oxygen gas transports automatically between the positive electrode and the gas store as it is generated or consumed in the positive electrode.

In an aspect, the oxygen in the gas store is configured to be pressure balanced with a support gas that is disposed in the gas store on a side of the barrier opposite the oxygen. The support gas may be any suitable gas, and may comprise nitrogen, argon, helium, or a combination thereof. Use of air is mentioned.

The gas store may further comprise a gas store fuel gauge configured to sense a pressure or a mass of the support gas in the gas store. Suitable gas store fuel gauges sensing pressure include a bourdon tube gauge, a diaphragm gauge, a bellows gauge, or a dead-weight gauge. Alternatively the gas store fuel gauge may sense a mass of the support gas. Suitable mass sensors include a micro cantilever sensor, a quartz crystal microbalance sensor, a surface acoustic wave sensor, a hotwire mass airflow sensor, or a vane type or flap type mass airflow sensor.

The gas store may comprises a first compartment and a second compartment, wherein the oxygen is stored in the first compartment and the support gas is disposed in the second compartment, wherein the first compartment and the second compartment are separated by the barrier. The barrier may be configured to maintain a same pressure in the first compartment and the second compartment, and the first compartment and the second compartment may be configured to be pressure balanced.

The barrier may be a movable piston, a moveable partition, a flexible diaphragm, an elastic diaphragm, an inflatable bladder, or a combination thereof. The barrier may comprise any suitable material, may comprise glass, metal, or wood. In an aspect, the barrier may comprise a polymeric material, and may be elastic. The barrier may be configured to move within the gas store. Alternatively, the barrier may be an elastic barrier, and the barrier may expand into the first compartment or the second compartment depending on the quantity of the support gas and oxygen.

In an aspect, the energy storage reactor comprises a metal store, and further comprising a metal store fuel gauge configured to sense a mass of metal in the metal store, a volume of metal in the metal store, or a combination thereof, wherein the metal store is in fluid communication with the energy storage reactor. Suitable mass sensors for the metal include a piezoelectric sensor, a quartz crystal microbalance sensor, or a mechanical resonator such as a resonator incorporated into a metal-oxide semiconductor. Suitable sensors for determining the volume of metal include a magnetic sensor, a resistance sensor, or a capacitive sensor.

In an aspect, the system is configured to operate passively, and without the action of a pump, a compressor, a blower, or a condenser.

If desired, a valve may be further disposed between the gas store and the positive electrode.

The metal-oxygen battery system may further comprise a heat exchanger configured to exchange heat between the energy storage reactor and the electrochemical cell.

In the metal-oxygen battery system, at least one of the energy storage reactor and the electrochemical cell may be disposed in a thermal chamber.

In the metal-oxygen battery system, the electrochemical cell may comprise a plurality of electrochemical cells. Each electrochemical cell of the plurality of electrochemical cells may be in electrical contact with an external circuit. A plurality of electrochemical cells may be used in the form of an electrochemical cell stack, e.g., to provide a selected voltage, in which the electrochemical cells are interconnected to form a “stack”. The entire stack may be removable from the metal-oxygen battery system. Also mentioned is a configuration in which the individual electrochemical cells of a stack are removable from the metal-oxygen battery system.

In an aspect, at least one electrochemical cell of the plurality of electrochemical cells may be a removable electrochemical cell. The at least one removable electrochemical cell may be configured to be selectively isolated from the metal-oxygen battery system. In an aspect, the at least one removable electrochemical cell may be configured to be selectively isolated from the gas store. In various aspects, it is possible to isolate the cell electrically, fluidically, mechanically, or thermally, and/or combinations and permutations thereof. In an aspect, each removable electrochemical cell can be configured to be independently isolated from the system. In another aspect, a grouping comprising a plurality of electrochemical cells can be isolated from the system; such a grouping can be advantageous because it reduces the cost of components and materials required to isolate electrochemical cells from the overall system. In certain aspects, the metal-oxygen battery system can be configured to operate when one or more of the removable electrochemical cells is isolated from the system and at least one electrochemical cell is not isolated from the system. In certain aspects, the metal-oxygen battery system may not be operable when removable electrochemical cells are isolated from the system.

The metal-oxygen battery system may further include a processor configured to receive information relating to the position of the barrier and to determine the state of charge based on the position of the barrier.

A battery fuel gauge may be configured to determine a state of charge of an metal-oxygen battery. The battery fuel gauge may comprise a processor configured to receive information relating to a position of a barrier of a gas store and to determine the state of charge based on the position of the barrier. The metal-oxygen battery may comprise an electrochemical cell, wherein the electrochemical cell may include a positive electrode, a negative electrode, and an electrolyte between the positive electrode and the negative electrode. The metal-oxide battery may further comprise an energy storage reactor in fluid communication with the negative electrode; and the gas store in fluid communication with the positive electrode. The gas store may be configured to store oxygen, wherein the gas store comprises the barrier. The gas store and the positive electrode of the electrochemical cell may form a closed system, or a system with a constant volume.

A method of operating the metal-oxygen battery system, the method may comprise:
providing the metal-oxygen battery system;
supplying electricity and water to the electrochemical cell to charge the battery system, wherein metal oxide and hydrogen are converted in the energy storage reactor to metal and water, water is converted to hydrogen and oxygen by the electrochemical cell, the hydrogen produced by the electrochemical reactor is transferred to the energy storage unit, and the oxygen produced by the electrochemical reactor is stored in the gas store; and
discharging the metal-oxygen battery system to covert hydrogen and oxygen to water and produce electricity, wherein metal and water are converted in the energy storage reactor to metal oxide and hydrogen, hydrogen and oxygen are converted to water by the electrochemical cell, the water produced by the electrochemical reactor is transferred to the energy storage reactor, and the oxygen is provided by the gas store.

Alternatively, disclosed is a method of operating the metal-oxygen battery system, the method may comprise:
providing the metal-oxygen battery system;
supplying electricity and carbon dioxide to the electrochemical cell to charge the battery system, wherein metal oxide and carbon monoxide are converted in the energy storage reactor to metal and carbon dioxide, carbon dioxide is converted to carbon monoxide and oxygen by the electrochemical cell, the carbon monoxide produced by the electrochemical reactor is transferred to the energy storage unit, and the oxygen produced by the electrochemical reactor is stored in the gas store; and
discharging the metal-oxygen battery system to covert carbon monoxide and oxygen to carbon dioxide and produce electricity, wherein metal and carbon dioxide are converted in the energy storage reactor to metal oxide and carbon monoxide, carbon monoxide and oxygen are converted to carbon dioxide by the electrochemical cell, the carbon dioxide produced by the electrochemical reactor is transferred to the energy storage reactor, and the oxygen is provided by the gas store.

The method of operating an metal-oxygen battery system can further comprise determining the state of charge of the metal-oxygen battery with a fuel gauge. The charging of the battery system may further comprise moving the barrier to a configuration having a greater volume of oxygen in the gas store. The discharging of the battery system may further comprise moving the barrier to a configuration having a smaller volume of oxygen in the gas store. This disclosure further encompasses the following aspects.

Aspect 1: An metal-oxygen battery system, comprising:
an electrochemical cell comprising a positive electrode, a negative electrode, and an electrolyte between the positive electrode and the negative electrode; and
an energy storage reactor in fluid communication with the negative electrode;
a gas store in fluid communication with the positive electrode, the gas store configured to store oxygen, wherein the gas store comprises a barrier; and
a fuel gauge configured to determine a state of charge based on a position of the barrier, wherein the gas store and the positive electrode form a closed system, or a system with a constant volume.

Aspect 2: The metal-oxygen battery system of aspect 1, wherein the metal-oxygen battery system is configured to generate an automatic gas flow between the positive electrode and the gas store.

Aspect 3: The metal-oxygen battery system of aspect 1 or 2, wherein the oxygen in the gas store is configured to be pressure balanced with a support gas that is disposed in the gas store on a side of the barrier opposite the oxygen.

Aspect 4: The metal-oxygen battery system of aspect 3, further comprising a gas store fuel gauge configured to sense a pressure or a mass of the support gas in the gas store.

Aspect 5: The metal-oxygen battery system of aspect 3 or 4, wherein the gas store comprises a first compartment and a second compartment, wherein the oxygen is stored in the first compartment and the support gas is disposed in the second compartment, wherein the first compartment and the second compartment are separated by the barrier.

Aspect 6: The metal-oxygen battery system of aspect 5, wherein the first compartment and the second compartment are configured to be pressure balanced.

Aspect 7: The metal-oxygen battery system of aspect 5, wherein the barrier is configured to maintain a same pressure in the first compartment and the second compartment.

Aspect 8: The metal-oxygen battery system of any of aspects 1 to 7, wherein the barrier is a movable piston, a moveable partition, a flexible diaphragm, an elastic diaphragm, an inflatable bladder, or a combination thereof.

Aspect 9: The metal-oxygen battery system of aspect 8, wherein the gas store comprises a first compartment and a second compartment, wherein the oxygen is stored in the first compartment and the support gas is disposed in the second compartment, and wherein the barrier is an elastic diaphragm that expands into the first compartment or the second compartment.

Aspect 10: The metal-oxygen battery system of any of aspects 1 to 9, wherein the energy storage reactor comprises a metal store, and further comprising a metal store fuel gauge configured to sense a mass of metal in the metal store, a volume of metal in the metal store, or a combination thereof, wherein the metal store is in fluid communication with the energy storage reactor.

Aspect 11: The metal-oxygen battery system of any of aspects 1 to 10, wherein the energy storage reactor comprises the metal store, and further comprising a metal store fuel gauge configured to sense a mass of metal oxide in the metal store, a volume of metal oxide in the metal store, or a combination thereof.

Aspect 12: The metal-oxygen battery system of any of aspects 1 to 11, wherein the electrochemical cell is configured to operate without a pump, a compressor, a blower, a condenser, or a combination thereof.

Aspect 13: The metal-oxygen battery system of any of aspects 1 to 12, further comprising a valve disposed between the gas store and the positive electrode.

Aspect 14: The metal-oxygen battery system of aspect 1, wherein the electrolyte comprises a solid oxide electrolyte, a molten carbonate electrolyte, or a combination thereof.

Aspect 15: The metal-oxygen battery system of aspect 1, wherein positive electrode comprises lanthanum strontium cobalt ferrite (LSCF), strontium-doped lanthanum manganate, strontium oxide and bismuth oxide doped with lanthanum manganate, lanthanum strontium cobaltite (LSC), barium strontium iron cobaltite (BSCF), strontium doped hafnium oxide, or europium cobaltite.

Aspect 16: The metal-oxygen battery system of aspect 1, wherein the negative electrode comprises nickel oxide (NiO), cerium oxide (CeO₂), copper oxide (CuO), strontium titanate (SrTiO₃), yttrium oxide doped strontium titanate (YST), or thorium oxide doped strontium titanate.

Aspect 17: The metal-oxygen battery system of any of aspects 1 to 16, further comprising a heat exchanger configured to exchange heat between the energy storage reactor and the electrochemical cell.

Aspect 18: The metal-oxygen battery system of any of aspects 1 to 17, wherein at least one of the energy storage reactor and the electrochemical cell are disposed in a thermal chamber.

Aspect 19: The metal-oxygen battery system of aspect 1, wherein the energy storage reactor is configured to convert metal to metal oxide and hydrogen in a discharge mode and configured to convert metal oxide to metal and water in a charge mode.

Aspect 20: The metal-oxygen battery system of aspect 1, wherein the energy storage reactor is configured to convert metal to metal oxide and carbon monoxide in a discharge mode and configured to convert metal oxide to metal and carbon dioxide in a charge mode.

Aspect 21: The metal-oxygen battery system of any of aspects 1 to 20, wherein the electrochemical cell comprises a plurality of electrochemical cells, wherein each electrochemical cell of the plurality of electrochemical cells is in electrical contact with an external circuit.

Aspect 22: The metal-oxygen battery system of aspect 21, wherein at least one electrochemical cell of the plurality of electrochemical cells is a removable electrochemical cell.

Aspect 23: The metal-oxygen battery system of aspect 22, wherein the at least one removable electrochemical cell is configured to be selectively isolated from the metal-oxygen battery system.

Aspect 24: The metal-oxygen battery system of aspect 22, wherein the at least one removable electrochemical cell is configured to be selectively isolated from the gas store.

Aspect 25: The metal-oxygen battery system of aspect 22, wherein the metal-oxygen battery system is configured to operate when the at least one removable electrochemical cells is isolated from the system and at least one electrochemical cell is not isolated from the system.

Aspect 26: The metal-oxygen battery system of any of aspects 1 to 25, further comprising a processor configured to receive information relating to the position of the barrier and to determine the state of charge based on the position of the barrier.

Aspect 27: The metal-oxygen battery system of any of aspects 1 to 26, wherein the energy storage reactor is:
disposed within a compartment of a negative electrode of the electrochemical cell;
disposed in a separate compartment from the electrochemical cell; or
disposed in an interconnect, wherein the electrochemical cell comprises a plurality of electrochemical cells that are connected via the interconnect.

Aspect 28: A battery fuel gauge configured to determine a state of charge of a metal-oxygen battery, wherein the battery fuel gauge comprises a processor configured to receive information relating to a position of a barrier of a gas store and to determine the state of charge based on the position of the barrier. The metal-oxygen battery comprises: an electrochemical cell comprising a positive electrode, a negative electrode, and an electrolyte between the positive electrode and the negative electrode; an energy storage reactor in fluid communication with the negative electrode; and the gas store in fluid communication with the positive electrode. The gas store is configured to store oxygen, wherein the gas store comprises the barrier. The gas store and the positive electrode of the electrochemical cell form a closed system, or a system with a constant volume.

Aspect 29: A method of operating a metal-oxygen battery system, the method comprising:
providing the metal-oxygen battery system of any of aspects 1 to 19 or aspects 21 to 27;
supplying electricity and water to the electrochemical cell to charge the battery system, wherein metal oxide and hydrogen are converted in the energy storage reactor to metal and water, water is converted to hydrogen and oxygen by the electrochemical cell, the hydrogen produced by the electrochemical reactor is transferred to the energy storage unit, and the oxygen produced by the electrochemical reactor is stored in the gas store; and
discharging the metal-oxygen battery system to covert hydrogen and oxygen to water and produce electricity, wherein metal and water are converted in the energy storage reactor to metal oxide and hydrogen, hydrogen and oxygen are converted to water by the electrochemical cell, the water produced by the electrochemical reactor is transferred to the energy storage reactor, and the oxygen is provided by the gas store.

Aspect 30: The method of aspect 29, further comprising determining the state of charge of the metal-oxygen battery system using the fuel gauge.

Aspect 31: The method of aspect 29 or 30, wherein the charging further comprises moving the barrier to a configuration having a greater volume of oxygen in the gas store.

Aspect 32: The method of any of aspects 29 to 31, wherein the discharging further comprises moving the barrier to a configuration having a smaller volume of oxygen in the gas store.

Aspect 33: A method of operating a metal-oxygen battery system, the method comprising:
providing a metal-oxygen battery system of any of aspects 1 to 18 or aspects 20 to 27;
supplying electricity and carbon dioxide to the electrochemical cell to charge the battery system, wherein metal oxide and carbon monoxide are converted in the energy storage reactor to metal and carbon dioxide, carbon dioxide is converted to carbon monoxide and oxygen by the electrochemical cell, the carbon monoxide produced by the electrochemical reactor is transferred to the energy storage unit, and the oxygen produced by the electrochemical reactor is stored in the gas store; and
discharging the metal-oxygen battery system to covert carbon monoxide and oxygen to carbon dioxide and produce electricity, wherein metal and carbon dioxide are converted in the energy storage reactor to metal oxide and carbon monoxide, carbon monoxide and oxygen are converted to carbon dioxide by the electrochemical cell, the carbon dioxide produced by the electrochemical reactor is transferred to the energy storage reactor, and the oxygen is provided by the gas store.

Aspect 34: The method of aspect 33, further comprising determining the state of charge of the metal-oxygen battery system using the fuel gauge.

Aspect 35: The method of aspect 33 or 34, wherein the charging further comprises moving the barrier to a configuration having a greater volume of oxygen in the gas store.

Aspect 36: The method of any of aspects 33 to 35, wherein the discharging further comprises moving the barrier to a configuration having a smaller volume of oxygen in the gas store.

The compositions, methods, and articles can alternatively comprise, consist of, or consist essentially of, any appropriate materials, steps, or components herein disclosed. The compositions, methods, and articles can additionally, or alternatively, be formulated so as to be devoid, or substantially free, of any materials (or species), steps, or components, which are otherwise not necessary to the achievement of the function or objectives of the compositions, methods, and articles.

All ranges disclosed herein are inclusive of the endpoints, and the endpoints are independently combinable with each other (e.g., ranges of “up to 25 wt %, or, more specifically, 5 wt % to 20 wt %”, is inclusive of the endpoints and all intermediate values of the ranges of “5 wt % to 25 wt %,” etc.). “Combinations” is inclusive of blends, mixtures, alloys, reaction products, and the like. The terms “first,” “second,” and the like, do not denote any order, quantity, or importance, but rather are used to distinguish one element from another. The terms “a” and “an” and “the” do not denote a limitation of quantity and are to be construed to cover both the singular and the plural, unless otherwise indicated herein or clearly contradicted by context. “Or” means “and/or” unless clearly stated otherwise. Reference throughout the specification to “some embodiments,” “an embodiment,” “an aspect,” and so forth, means that a particular element described in connection with the embodiment and/or aspect is included in at least one embodiment and/or aspect described herein, and may or may not be present in other embodiments and/or aspects. In addition, it is to be understood that the described elements may be combined in any suitable manner in the various embodiments and/or aspects. A “combination thereof” is open and includes any combination comprising at least one of the listed components or properties optionally together with a like or equivalent component or property not listed.

Unless specified to the contrary herein, all test standards are the most recent standard in effect as of the filing date of this application, or, if priority is claimed, the filing date of the earliest priority application in which the test standard appears.

Unless defined otherwise, technical and scientific terms used herein have the same meaning as is commonly understood by one of skill in the art to which this application belongs. All cited patents, patent applications, and other references are incorporated herein by reference in their entirety. However, if a term in the present application contradicts or conflicts with a term in the incorporated reference, the term from the present application takes precedence over the conflicting term from the incorporated reference.

While particular embodiments have been described, alternatives, modifications, variations, improvements, and substantial equivalents that are or may be presently unforeseen may arise to applicants or others skilled in the art. Accordingly, the appended claims as filed and as they may be amended are intended to embrace all such alternatives, modifications variations, improvements, and substantial equivalents.

What is claimed is:

1. A metal-oxygen battery system, comprising:
an electrochemical cell comprising
a positive electrode,
a negative electrode, and
an electrolyte between the positive electrode and the negative electrode; and
an energy storage reactor in fluid communication with the negative electrode;
a gas store in fluid communication with the positive electrode, the gas store configured to store oxygen; and
a fuel gauge configured to determine a state of charge,
wherein the gas store and the positive electrode form a closed system.

2. The metal-oxygen battery system of claim 1,
wherein the gas store comprises a barrier, and the fuel gauge is configured to determine a state of charge based on a position of the barrier;
wherein the metal-oxygen battery system is configured to generate an automatic gas flow between the positive electrode and the gas store;
wherein the gas store comprises a barrier, and wherein the oxygen in the gas store is configured to be pressure balanced with a support gas that is disposed in the gas store on a side of the barrier opposite the oxygen;
further comprising a gas store fuel gauge configured to sense a pressure or a mass of the support gas in the gas store;
further comprising a valve disposed between the gas store and the positive electrode;
wherein the gas store comprises a barrier, and further comprising a processor configured to receive information relating to the position of the barrier and to determine the state of charge based on the position of the barrier;
wherein at least one of the energy storage reactor and the electrochemical cell are disposed in a thermal chamber; or
a combination thereof.

3. The metal-oxygen battery system of claim 1, wherein the gas store comprises a first compartment and a second compartment, wherein the oxygen is stored in the first compartment and the support gas is disposed in the second compartment, wherein the first compartment and the second compartment are separated by a barrier.

4. The metal-oxygen battery system of claim 3,
wherein the first compartment and the second compartment are configured to be pressure balanced;
wherein the barrier is configured to maintain a same pressure in the first compartment and the second compartment;
wherein the barrier is a movable piston, a moveable partition, a flexible diaphragm, an elastic diaphragm, an inflatable bladder, or a combination thereof; or
a combination thereof.

5. The metal-oxygen battery system of claim 1, wherein the gas store comprises a barrier, a first compartment, and a second compartment, wherein the oxygen is stored in the first compartment and a support gas is disposed in the second compartment, and wherein the barrier is an elastic diaphragm that expands into the first compartment or the second compartment.

6. The metal-oxygen battery system of claim 1,
wherein the energy storage reactor comprises a metal store, and
further comprising a metal store fuel gauge configured to sense a mass of the metal in the metal store, a volume of the metal in the metal store, or a combination thereof, wherein the metal store is in fluid communication with the energy storage reactor,
wherein the metal is iron, tin, tungsten, cobalt, zinc, molybdenum, cadmium, copper, lead, or a combination thereof.

7. The metal-oxygen battery system of claim 1, wherein the electrochemical cell is configured to operate in a passive mode without a pump, a compressor, a blower, a condenser, or a combination thereof, or
wherein the electrochemical cell is configured to operate in an active mode and comprises a pump, a compressor, a blower, a condenser, or a combination thereof, and further comprising a pressure drop fuel gauge configured to sense a pressure drop across the energy storage reactor.

8. The metal-oxygen battery system of claim 1, wherein the electrolyte comprises a solid oxide electrolyte, a molten carbonate electrolyte, or a combination thereof.

9. The metal-oxygen battery system of claim 1, wherein positive electrode comprises lanthanum strontium cobalt ferrite, strontium-doped lanthanum manganate, strontium oxide and bismuth oxide doped with lanthanum manganate, lanthanum strontium cobaltite, barium strontium iron cobaltite, strontium doped hafnium oxide, europium cobaltite, or a combination thereof.

10. The metal-oxygen battery system of claim 1, wherein the negative electrode comprises nickel oxide, cerium oxide, copper oxide, strontium titanate, yttrium oxide doped strontium titanate, thorium oxide doped strontium titanate, or a combination thereof.

11. The metal-oxygen battery system of claim 1, further comprising a heat exchanger configured to exchange heat between the energy storage reactor and the electrochemical cell.

12. The metal-oxygen battery system of claim 1, wherein the energy storage reactor is:
configured to convert a metal to a metal oxide and hydrogen in a discharge mode; and
configured to convert the metal oxide to the metal and water in a charge mode.

13. The metal-oxygen battery system of claim 1, wherein the energy storage reactor is:
configured to convert a metal to a metal oxide and carbon monoxide in a discharge mode; and
configured to convert the metal oxide to the metal and carbon dioxide in a charge mode.

14. The metal-oxygen battery system of claim 1, wherein the electrochemical cell comprises a plurality of electrochemical cells, wherein each electrochemical cell of the plurality of electrochemical cells is in electrical contact with an external circuit.

15. The metal-oxygen battery system of claim 14, wherein at least one electrochemical cell of the plurality of electrochemical cells is a removable electrochemical cell.

16. The metal-oxygen battery system of claim 15,
wherein the at least one removable electrochemical cell is configured to be selectively isolated from the metal-oxygen battery system;
wherein the at least one removable electrochemical cell is configured to be selectively isolated from the gas store;
wherein the metal-oxygen battery system is configured to operate when the at least one removable electrochemical cells is isolated from the system and at least one electrochemical cell is not isolated from the system; or
a combination thereof.

17. The metal-oxygen battery system of claim 1, wherein the energy storage reactor is:
disposed within a compartment of a negative electrode of the electrochemical cell;
disposed in a separate compartment from the electrochemical cell; or
disposed in an interconnect, wherein the energy storage reactor comprises a plurality of electrochemical cells that are connected via the interconnect.

18. A battery fuel gauge configured to determine a state of charge of a metal-oxygen battery,
wherein the battery fuel gauge comprises a processor configured to receive information relating to a position of a barrier of a gas store and to determine the state of charge based on the position of the barrier;
wherein the metal-oxygen battery comprises:
an electrochemical cell comprising
a positive electrode,
a negative electrode, and
an electrolyte between the positive electrode and the negative electrode;
an energy storage reactor in fluid communication with the negative electrode; and
the gas store in fluid communication with the positive electrode, the gas store configured to store oxygen, wherein the gas store comprises the barrier,
wherein the gas store and the positive electrode of the electrochemical cell form a closed system, or a system with a constant volume.

19. A method of operating a metal-oxygen battery system, the method comprising:
providing the metal-oxygen battery system of claim 1;
supplying electricity and water to the electrochemical cell to charge the battery system, wherein
metal oxide and hydrogen are converted in the energy storage reactor to metal and water,
water is converted to hydrogen and oxygen by the electrochemical cell,
the hydrogen produced by the electrochemical reactor is transferred to the energy storage unit, and
the oxygen produced by the electrochemical reactor is stored in the gas store; and
discharging the metal-oxygen battery system to covert hydrogen and oxygen to water and produce electricity, wherein
metal and water are converted in the energy storage reactor to metal oxide and hydrogen,
hydrogen and oxygen are converted to water by the electrochemical cell,
the water produced by the electrochemical reactor is transferred to the energy storage reactor, and
the oxygen is provided by the gas store.

20. The method of claim 19,
further comprising determining the state of charge of the metal-oxygen battery system using the fuel gauge;
wherein the charging further comprises moving a barrier of the gas store to a configuration having a greater volume of oxygen in the gas store;
wherein the discharging further comprises moving the barrier of the gas store to a configuration having a smaller volume of oxygen in the gas store; or
a combination thereof.
